(19) United States
(12) Patent Application Publication
(10) Pub. No.: US 2001/0025259 A1
(43) Pub. Date: Sep. 27, 2001

(54) Radio station digital music distribution system and method

(76) Inventor: Pierre Rouchon, Ypsilanti, MI (US)

Correspondence Address: Kevin R. Erdman, Baker & Daniels, Suite 2700, 300 North Meridian Street, Indianapolis, IN, 46204, US

(21) Appl. No.: 09/797,164

(22) Filed: Mar. 1, 2001

Related U.S. Application Data
(60) Provisional application No. 60/186,501, filed on Mar. 2, 2000.

(51) Int. Cl. G06F 17/60

(52) U.S. Cl. 705/26; 705/10

(57) ABSTRACT

The present invention involves a system and method of distributing music to radio station listeners over a public computer network. First, a distribution center for distributing electronically stored music is required. Second, the distribution center has an interface for independent music artists to contribute electronically stored music to the distribution center. Next, an interface for radio stations is provided to refer listeners to the distribution center. The interface for radio stations gathers information from the listeners during the distribution process. The distribution center includes an interface for electronic commerce relating to the distribution of electronically stored music.

### BACKGROUND OF THE INVENTION

1. Field of the Invention

The invention relates to digital music recordings and software systems for music recordings. More specifically, the field of the invention is that of independent music distribution for music artists.

2. Description of the Related Art

The Market Tracking International report for 1997 reported that worldwide retail sales in the music industry were $39.7 billion and are expected to grow to $46.9 billion by 2004. The music industry can be divided into two kinds of record companies or “labels” - - - the “major” record labels and the “independent” record labels. The five major record labels and their affiliates currently account for approximately 79% of all recorded music sales worldwide. These companies are BMG Entertainment, EMI Music, Sony Music Entertainment, Universal Music Group and Warner Music Group. These companies have substantial investments in the distribution infrastructure that supports the manufacturing, distribution and retailing of records and compact discs and through which the substantial majority of current recorded music sales take place. Historically, the major record labels have been reluctant to participate in any alternative distribution model that would restructure the current music distribution hierarchy due to their investment in the current physical distribution infrastructure and their relationship with the retail channel.

Thousands of independent record labels account for most of the remaining recorded music sales. In contrast to major record labels, independent record labels generally do not have substantial existing CD and record distribution investments and, as a result, physical distribution can be more difficult and costly to arrange. Independent record labels typically have less capital available. Without the established distribution networks, independent record labels often pay higher royalties to artists to secure publishing and distribution rights.

There are an estimated 90 million (February 1999) Internet users in the US representing 33% of the population, with growth rates estimated from 20% to 50% or more annually. The Internet has emerged as a global platform that allows millions of people to share information, communicate and conduct business. International Data Corporation estimates that the number of Internet users worldwide who make purchases over the Internet will grow from approximately 31 million users in 1998 to more than 183 million in 2003, representing 36% of all Internet users. The Internet presents a significant opportunity for the rapid and cost-effective distribution, promotion and sale of recorded music. Downloading music files is also facilitated by the increased use of high-speed connections to the Internet, such as digital cable modems, ISDN and digital subscriber lines. According to Forrester Research, the number of subscribers using cable, xDSL or ISDN modems is projected to reach 22 million by 2003.

Online music revenues in the United States are expected to grow from $89.0 million in 1998 to $7.8 billion in 2003 according to Forrester. Of this amount, Forrester further estimates that $1.1 billion will represent sales of downloadable music in 2003. According to Market Tracking International, music sold through the Internet will account for 8% or approximately $4.0 billion of the $46.9 billion worth of music expected to be sold worldwide in 2004. However, the current state of the online music industry has been characterized by “freebies.” Online music retailers like Amazon and CDNow find that posting free MP3 songs of popular artists are a very effective promotional tool for selling CD's. Sites like MP3.com offer a plethora of free music from unsigned artists, again as a tool to promote a bands awareness and popularity. All this reinforces the notion that online digital music is not something one pays for.

Consumer adoption of downloadable music creates an excellent opportunity for independent record labels to supplement or replace their physical distribution networks with electronic channels. Currently, most independent record labels rely on the distribution infrastructure of major record labels to distribute their offerings. They are subject to constraints of these physical channels, such as higher distribution costs driving lower margins, limited shelf space and subordination to the offerings of the major record labels, as well as more limited promotional capabilities. While the promise of an electronic distribution infrastructure is compelling, most independent record labels lack the resources and expertise to create a viable proprietary electronic distribution channel.

One known website by Billboard describes a service as “the first professionally oriented online showcase for new and developing artists in every genre. The site provides an enhanced 24-hour global, interactive link to the world of emerging talent like yourself—well before they hit it big.” The Billboard Talent Net Store, based in Germany, provides unsigned and developing artists with a comprehensive sales web site destination.

CDNOW, Inc. is another online music destination that offers a comprehensive, personalized connection to the world of music. CDNOW's offerings consist of more than 500,000 music and entertainment-related items, including CDs, DVDs, videos, cassettes, vinyl albums, custom CDs and music downloads, as well as music samples, intelligent album recommendations, a vast library of interviews and reviews from top music writers, music news from all-star News. CDNOW has established a strategic partnership with the UK-based Ministry of Sound, one of the most influential independent labels in the British music business.

MP3.com has an online music destination. Internet and file formats that make music files smaller to enable a growing number of artists to distribute and promote their music to a broad audience and to let consumers conveniently access this expanding music catalogue. The website contains more than 180,000 songs from more than 31,000 artists, representing one of the largest collections of digital music available on the Internet. Consumers can search, preview and download music free of charge. Unfortunately, it is difficult to navigate the many songs in library of the website. Another difficulty of this website is that MP3.com is not supported by major record companies.

Another mp3 formatted download site is EMusic.com, one of the first sites to employ a pay-per single-model for selling digital music. Through direct relationships with leading artists and exclusive licensing agreements with independent record labels, EMusic.com offers an expanding collection of tracks for purchase—entire albums for one price or individual tracks for a lesser price. EMusic.com features top artists in all musical genres.

Mjuice.com (formerly Audio Explosion) is a global media company that delivers digital music to fans looking to purchase, download and play music files via the Internet. Mjuice.com has one of the Web's largest catalogs of fully-licensed independent label music with a music download system. Mjuice.com offers new release material, advance singles, promotions and the latest music news and information from major and independent artists and labels, all of which are releasing digital content on the Web in a secure format. To meet the needs of high-profile artists, publishers and labels, Mjuice.com developed a secure digital song delivery and transaction system that ensures proper compensation for music, while removing the threat of online piracy. The Mjuice mp3 formatted song files provide a high level of security for music rights holders while maintaining mp3's excellent sound quality and instant recognition among Web music fans.

Garageband.com is an on-line community created by musicians for musicians. It's where fans, emerging talent, and industry pros meet as equals, listen to tracks uploaded from garageband.com members, and vote on which bands receive $250,000 recording contracts. This company has designed a new methodology for quantitatively analyzing mass audience preferences on the Internet. Through the use of the audience aggregation power of the web and a proprietary process (the Lathroum Comparator Engine or “LCE”), garageband.com intends to create a new kind of internet music company. The LCE allows musicians and their fans to rate each other's music. LCE allows these ratings to occur in context and without bias—something not afforded by the trivial ratings meters used as promotional gimmicks on other music sites. Application of the LCE will ultimately lead to a virtual “battle of the bands” from which only the most popular are selected. The Company intends to sign artists with this now proven potential, and pair these artists with established record producers from its advisory board. For the musician, garageband.com has assembled music industry professionals to collaborate on the Internet. The site claims to be the “authoritative site” offering real artist development. Because of its affiliation with a broad range of producers, engineers and mixers, garageband.com is positioned as the one site where real musicians hang out, distinguishing it from other web sites which indiscriminately seek to aggregate as many mp3 files as possible. For the listener, garageband.com offers a backstage pass. The website allows the listener to be a part of an intelligent process for determining what music will be recorded. Fans are encouraged to visit the site, and submit reviews of songs. In return, fans will earn frequent reviewer points redeemable for prizes.

Musicmaker.com is the largest custom compilation CD and secure digital download music site on the Internet. Musicmaker.com offers music lovers the opportunity to build their own CD's by selecting and organizing songs from a library approaching 200,000 tracks from over 100 labels, including EMI Recorded Music, Virgin Records, Capital Records, Zomba, Jive, Platinum, Fantasy, Rounder, Alligator, Roadrunner, and TVT, to name a few. Musicmaker's library spans a wide range of music genres, including rock, alternative, pop, hip-hop, jazz, punk, classical, blues and country. Powerful search engines help find selections by genre, artist, title and label, and RealAudio allows tracks to be sampled before selection. CD's include up to 20 tracks or 70 minutes of music and can be personalized with unique labels as well as imprints on jewel boxes. Musicmaker.com offers nearly 100,000 licensed songs in three secure digital downloading formats: Liquid Audio, Microsoft MS Audio 4.0 and a musicmaker.com proprietary secure mp3 format. Each digitally downloaded track is available at a set fee per song. Musicmaker.com also has exclusive marketing agreements with Columbia House, the world's largest music club, Tunes.com, RollingStone.com, Downbeatjazz.com, thesource.com, Audio Book Club, Platinum Entertainment and Woodstock.com.

ARTISTdirect connects music fans directly with their favorite artists worldwide via an online network, “The ARTISTdirect Network.” The Network is designed to provide multi-media music entertainment, news and information, create music communities to facilitate interaction between artists and fans, and provide exclusive music and merchandise direct from the artists themselves. The Network consists of: ARTISTdirect.com. (www.artistdirect.com), home of the official online channels that we operate and maintain on behalf of high-profile artists; UBL (www.ubl.com), a comprehensive music portal and search engine with a database of more than 70,000 artists and millions of links; iMusic (www.imusic.com), the premier online music community site with message boards and chats; DOWNLOADSdirect (www.downloadsdirect.com), the music download hub which showcases downloads from high-profile artists as well as independent bands; and the ARTISTdirect Superstore, a full-service online retail store with a broad range of music CD's and artist merchandise.

Liquid Audio is also a provider of services and software that enable musicians, record labels and music retailers to digitally-deliver professional-quality music via the Internet. Formed by veterans of the music industry and professional recording engineers, Liquid Audio is leading the convergence of music and technology to establish the Internet as a new medium for music distribution. The company's products and services are based on an open architecture that supports all leading digital music formats, including Dolby AC3, and mp3. This open architecture will also enable Liquid System products to be compliant with the goals of the Record Industry Association of America's Secure Digital Music Initiative (SDMI). Liquidaudio offers a service called Liquid Platinum that allows users to sell music securely over the web. This service has distribution on more than 200 sites including Web Portals like Yahoo!, Music Retailers like Towerrecords.com, Radio stations like KALZ, Music Communities like Listen.com. Liquid Audio's encoded downloads give users a credible tool to pitch the labels and demonstrate their potential. Their website also allows users to publish free promotional tracks to push new CD or sell tracks at a price the user chooses, allowing the user to keep a set percentage of the retail price on tracks sold by others, and a higher percentage on songs the user sells itself.

RealNetworks is the established market leader in streaming media technology on the Internet. It is helping transform the Internet into the next mass medium by making real-time, or streaming, Internet broadcasting possible and profitable. In only four years, RealNetworks software systems have become by far the most pervasive method of streaming media on the Internet and intranets.

Yahoo! Inc. is a global Internet media company that offers a branded network of comprehensive information, communication and shopping services to millions of users worldwide. As the first online navigational guide to the Web, www.yahoo.com is the leading guide in terms of traffic, advertising, household and business user reach, and is one of the most recognized brands associated with the Internet. The company's global Web network includes 19 World properties. Yahoo! has offices in Europe, the Asia Pacific, South America, Canada and the United States, and is headquartered in Santa Clara, Calif. Yahoo! users can take their musical talents beyond the privacy of their own showers and cars and onto the Internet. Yahoo! Open Mic (http://digital.yahoo.com), in collaboration with IUMA (Internet Underground Music Archive) and LiquidAudio, Inc., gives musicians of all levels the opportunity to self publish and sell their own music online. From an up-and-coming jazz pianist to a garage band on the verge of making it big, those users who submit their own music will be playing to one of the world's single largest music crowds the millions of unique monthly users on Yahoo!. Yahoo! Open Mic is part of Yahoo! Digital, a multimedia digital property that combines the best of audio, video and interactive content. Yahoo! Digital provides users with the ability to watch and listen to Internet broadcasts from today's top music talent; preview music as well as download and purchase both secure and open audio files, including mp3; remix selected music tracks online; view on-demand video channels; and browse a licensed music directory.

Amazon.com has an Advantage Program designed specifically to allow independent labels and artists sell their music over the Internet. As part of the Advantage Program, users can list a user's CD in the Amazon.com catalog so fans everywhere know where they can easily buy the user's CD. Each CD can be promoted to customers by displaying its cover art, providing track samples, offering it with immediate availability for delivery, and displaying liner notes and CD information. When a CD is listed at Amazon.com, customers can always find it if they are looking specifically for it using Artist and Title searches. However, many of Amazon.com customers don't have a specific purchase in mind. They come to our shelves hoping to discover cool new music. By joining Advantage, Amazon.com classifies the CD so that it qualifies to show up on the top 50 lists. Amazon.com also has special sections of these lists for Undiscovered CDs to help fans in search of the next big thing in music.

### SUMMARY OF THE INVENTION

The present invention is an internet based system and method which allows small, independent artists to directly market and sell their music in electronic form. The system and method also provides for localized data collection and analysis for businesses, such as radio stations, which allows for the businesses to learn more about their customers and have a greater ability to deliver music and other goods and services desired by those customers. In addition, localized data collection can then be aggregated between businesses to give each businesses a broader view of the market.

By supporting independent artists, downloadable music creates a compelling solution for artists. In return for access to the powerful distribution and promotion capabilities of the major record labels, major label artists are generally required to lock themselves into long-term contracts that can reduce their royalty rates, limit their creative control and limit their ability to promote and sell their music online. Artists who work with an independent record label tend to enjoy less restrictive contracts, but must face risks associated with an independent record label's less effective distribution and promotion capabilities. Additionally, physical channels require costly promotional efforts, making it difficult for some artists to promote their offerings to a large audience. The cost and contractual constraints of the major record labels and the limitations of independent record labels using traditional distribution channels will encourage many artists, including some major artists, to offer their music in downloadable format, either on their own or through an independent record label with electronic distribution capability.

The ability to accurately track and make royalty payments to the correct parties is crucial to the proliferation of the downloadable music distribution channel as a viable alternative to their physical counterparts. Rights in the music industry focus on two levels; the underlying song and the sound recording. The purchase of one song usually requires at least two separate royalty payments, one to the songwriter and one to the performer. Creating an infrastructure to handle royalty payments for downloadable music is difficult, and the lack of this infrastructure has slowed acceptance of the downloadable music distribution channel by artists, labels and songwriters.

With the present invention, independent artists have more control over the distribution of their music via the Internet. By linking to a web site operating in accordance with the present invention, independent artists can launch their own websites and sell their music directly to the consumer. This business method of using a network of radio stations yields tremendous power to the larger radio station conglomerates.

The present invention, in one form, relates to method of distributing music to radio station listeners over a public computer network. First, a distribution center for distributing electronically stored music is provided. Second, an interface for independent music artists to contribute electronically stored music to the distribution center is provided. Next, an interface for radio stations to refer listeners to the distribution center is provided. The interface for radio stations gathers information from the listeners during the distribution process. The distribution center includes an interface for electronic commerce relating to the distribution of electronically stored music.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the transactions possible using the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The present invention involves providing structure and organization to the thousand songs available from independent music artists. Currently, the consumer is only exposed to the music of recording artists from large record labels via radio airplay. The present invention helps promote the best songs of the “unknown” artists by providing a music ranking service over the Internet. Within the business model of the present invention, the song of an “unknown” artist we need to go through the following steps to become popular:

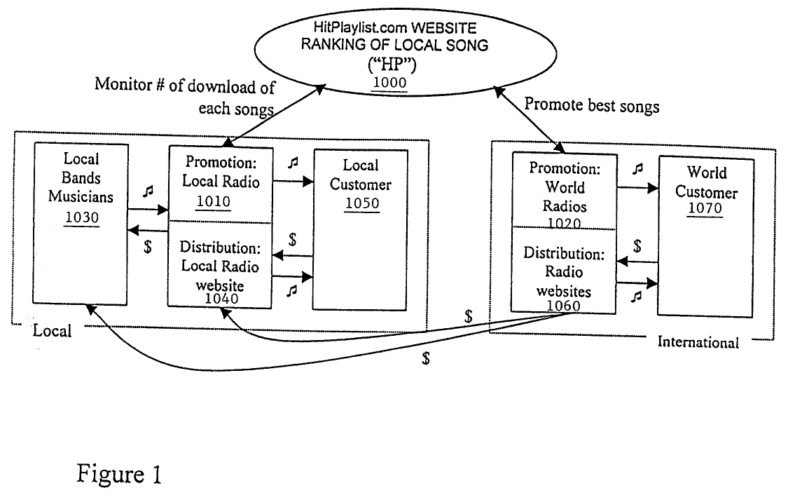

In its business model, the HitPlaylist.com website (hereinafter “HP”) will first detect the best songs at a local level (see the “Local” cell in FIG. 1). Musicians will visit their local radio stations and ask to have their songs aired. If the radio station's DJ believes the song fits with its audience taste, the song will be aired. While airing the song, the DJ will also mention that the song is available for download at the radio station web site. Afterward, if the listener liked the song and wishes to purchase it, she/he will simply log onto the radio station web site and follows the “Buy song” link. That link will direct the customer to HP's web site where the play-list of the radio station is displayed. Then, the customer will simply click on the “Buy” button next to the song he/she wants to purchase. After entering her/his credit information, the song will be downloaded to the customer's computer.

FIG. 1 shows an object oriented schematic of the interaction of the various computer systems and users involved in such a transaction. The HP website 1000 is pointed to by various radio stations (both the local radio 1010 and the world radios 1020). The radio stations, both local and world, have promotion and distribution aspects of their objects. The promotion object of the radio station object receives music from local bands 1030, both conventionally and possibly digitally, and advertises local bands through broadcast announcements and playing the local bands as part of the station's playlist. The distribution object of the radio station object involves the radio station's website 1040 having a link to the HP object that allows local customers 1050 to access the HP website through the local radio station website. The HP website conducts the downloading of music and accounting of such downloading, and facilitates the transfer of funds from the local customer to the local bands in conjunction with the radio station website. To facilitate the reach of local bands to the world music scene, HP maintains a ranking of local song activity for that world radio stations websites 1060 may monitor and access the local music and promote and distribute local music to the world customer 1070. Thus the present invention allows local bands to get exposure to their local market without requiring the intervention of a recording studio, and allows for the possibility of expanding the reach of the local band to the international market.

During the interchange with local and world customers, HP has the opportunity to gather data from those customers. That customer data can be aggregated and provided to the local and world radio stations so that those stations can tailor their offerings to their customers needs and desires. This is particularly important for local radio stations, because composite information on listener's needs and desires is often difficult or impossible to statistically sample. With the present invention, assuming sufficient usage of the music downloading services of the HP website, local radio stations can obtain far greater amounts of listener data than through conventional methods.

HP monitors the number of downloads as well as the customer profile. HP uses this information to generate a worldwide music ranking of the most popular songs. The music ranking will subsequently be used by all radio stations around the world to build their play-list (see cell “International” above). Again, while broadcasting songs, radio stations will mention that music is available for download at their web site so customers around the world will be able to purchase the music. Similarly, at the local radio web site, the customer will follow a link to HP web site to make his transaction and HP will monitor the number of downloads.

The HP business model will increase the exposure of independent artists. The current state of the music industry requires artists to sign long term contracts with one of the five large record labels. New artists have a slim chance of being signed to a major record label and gaining worldwide exposure. In the HP business model, independent artists contract an individual song with one of HP's partnering local radio stations and get their music aired right away. In the meantime, HP handles their music distribution and the payment transactions to the final customer, making the whole experience very easy for the artists. To customize customer offerings, HP may study customer profile information and suggest an optimum price. Artists have the final word as to whether the song shall be priced at HP suggested price or not. Artists have also the right to set the price at $0 if they wish.

To radio stations, HP provides a worldwide music ranking to build their playlists. HP also provides sales figures for each song aired by one radio station to allow DJs to identify the most popular songs given their specific audience. Finally, HP also compiles customer profile statistics and define the target audience for each song. Therefore, when a DJ identifies a popular song, she/he can consult the statistics to view a list of related purchases by customers who also downloaded that song. These tools will help DJs to further customize their play-lists according to the taste of their audience.

To other businesses, such as record labels, event organizers, advertisers, and merchandisers, for example, the aggregate demographic data relating to the playlists provides useful information about the listening habits and other preferences of the listeners. Such aggregated information may be provided on a radio station specific basis, on a group basis, or may be otherwise organized according to other data parameters (physical location, type of music preference, age, gender, or other demographic). This aggregate information does not need to have any personally identifiable information, although such information could be included. Such aggregate data may also be computed for given time periods as compared with aggregate data of other songs or artists. The aggregate information can also be used to maintain playlists that rank various artists for all radio stations, for only one or a subset of the radio stations, or sorted by other demographic information. Consequentially, this can give such businesses precise information for specific songs or artists. The sequential steps involved in the transactions contemplated by FIG. 1 are as follows:

Step 1: Independent artists sell their songs to their local radio stations. Independent artists shall contact DJs at local radio station and request them to air their songs. The first radio station that agrees to air the song will sign an exclusivity contract with the artist. In details, the contract will mention information such as price of the song, percentage of profit share between the artist, radio station and HP, and copyright restriction.

Step 2: The local radio station air and sell the song. The local radio will aired the song and mentioned to its audience that the song is also available for download at the radio station website. The radio station website will have a special link to download the song. That link will direct the customer to HP website where he/she will input personal and credit information to pay and download the song. With such a system, HP will centralize all of the e-commerce transaction thus limiting cost to the radio station and artist.

Step 3: MB will include the song on its chart. By analyzing the number of download of the song of the given radio station, HP will estimate the popularity of the song. The song along with popularity score will be placed on the HP chart.

Step 4: Other radio stations will include HP songs on their play-list. Radio station belonging to the HP network will have access to HP chart. DJs will therefore add new popular songs onto their playlist. Here again, when airing the song, DJs will mention that the song is available for download at the radio website. The radio station website will direct customer to HP site to purchase the song. With such a system, popular songs will not only be aired at the local radio mentioned in step 1 but also at all the radio stations belonging the HP network thus increasing the sale of popular songs.

Step 5: HP will redistribute profit to the different parties. HP final task will be to redistribute profit to the different parties as mentioned on the contract established in step 1.

In conclusion, the HP website provides value for all the participants: independent music artists increase exposure and have a greater earning potential; the local radio stations are provided a profit opportunity when launching new songs, access to a worldwide selection of music, and direct feedback from their audience; the customer has a larger selection of music and a lower cost via purchase over the Internet.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of distributing music to individual radio station listeners over a public computer network comprising the steps of:
providing a distribution center for distributing electronically stored music;
providing an interface for independent music artists to contribute electronically stored music to the distribution center;
providing an interface for radio stations to refer individuals to the distribution center; and
allowing individuals to obtain electronically stored music from the distribution center and enabling the individuals obtaining the electronically stored music to provide payment to independent music artists.

2. The method of claim 1 wherein the distribution center includes an interface for electronic commerce relating to the distribution of electronically stored music and the collection of royalties for the distribution of electronically stored music.

3. The method of claim 1 wherein the distribution center includes a server and a software program for transmitting and receiving electronically stored music and payment information with the independent music artists and the individuals obtaining the electronically stored music.

4. The method of claim 1 wherein the interface for radio stations gathers demographic information from the individuals during the distribution process.

5. The method of claim 4 wherein the distribution center aggregates the demographic information received from a plurality of individuals.

6. The method of claim 5 further comprising the step of providing aggregate demographic information for individuals referred from specific radio stations.

7. The method of claim 6 further comprising the step of providing aggregate demographic information of the individuals referred from a plurality of radio stations.

8. In computer, a method of distributing music to individual radio station listeners over a public computer network, said method comprising the steps of:
providing a distribution center for distributing electronically stored music;
providing an interface for independent music artists to contribute electronically stored music to the distribution center;
providing an interface for radio stations to refer listeners to the distribution center; and
allowing individuals to obtain electronically stored music from the distribution center and enabling the individuals obtaining the electronically stored music to provide payment to independent music artists.

9. The method of claim 8 wherein the distribution center includes an interface for electronic commerce relating to the distribution of electronically stored music and the collection of royalties for the distribution of electronically stored music.

10. The method of claim 8 wherein the distribution center includes a server and a software program for transmitting and receiving electronically stored music and payment information with the independent music artists and the individuals obtaining the electronically stored music.

11. The method of claim 8 wherein the interface for radio stations gathers demographic information from the individuals during the distribution process.

12. The method of claim 11 wherein the distribution center aggregates the demographic information received from a plurality of individuals.

13. The method of claim 12 further comprising the step of providing aggregate demographic information for individuals referred from specific radio stations.

14. The method of claim 14 further comprising the step of providing aggregate demographic information of the individuals referred from a plurality of radio stations.

15. A machine-readable program storage device for storing encoded instructions for a method of distributing music to radio station individual listeners over a public computer network, said method comprising the steps of:
providing a distribution center for distributing electronically stored music;
providing an interface for independent music artists to contribute electronically stored music to the distribution center;
providing an interface for radio stations to refer listeners to the distribution center; and
allowing individuals to obtain electronically stored music from the distribution center and enabling the individuals obtaining the electronically stored music to provide payment to independent music artists.

16. The machine-readable program storage device of claim 15 wherein the distribution center includes an interface for electronic commerce relating to the distribution of electronically stored music and the collection of royalties for the distribution of electronically stored music.

17. The machine-readable program storage device of claim 16 wherein the distribution center includes a server and a software program for transmitting and receiving electronically stored music and payment information with the independent music artists and the individuals obtaining the electronically stored music.

18. The machine-readable program storage device of claim 15 wherein the interface for radio stations gathers demographic information from the individuals during the distribution process.

19. The machine-readable program storage device of claim 18 wherein the distribution center aggregates the demographic information received from a plurality of individuals.

20. The machine-readable program storage device of claim 19 wherein the method further comprises the step of providing aggregate demographic information for individuals referred from one of a specific radio station and from a plurality of radio stations.
